(19) United States
(12) Patent Application Publication
(10) Pub. No.: US 2021/0059478 A1
(43) Pub. Date: Mar. 4, 2021

(54) V-shaped interfolded paper sheet of predetermined size for use in cooking and food fields and relative dispenser

(71) Applicant: Andrea Bernacchi, Capannori (IT)

(72) Inventor: Andrea Bernacchi, Capannori (IT)

(21) Appl. No.: 17/250,039

(22) PCT Filed: May 3, 2019
(86) PCT No.: PCT/IB2019/053638

§ 371 Date: Nov. 10, 2020

(30) Foreign Application Priority Data
May 14, 2018 (IT) 202018000002543

(51) Int. Cl. A47J 47/01; A47K 10/42; A01N 25/10; A01N 25/34

(52) U.S. Cl. CPC A47J 47/01; A47K 10/424; A47K 2010/428; A01N 25/34; A01N 25/10

(57) ABSTRACT

A pile of folded or interfolded paper sheets for use in cooking or food applications includes sheets having a rectangular shape defined by a side that shapes the length of the sheet and a side that shapes the width of the sheet. The length of the sheet is from 20 cm to 42 cm and the width of the sheet in a range from 25 cm to 40 cm. A dispenser for containing the pile of folded or interfolded sheets is configured to contain, and enabled to collect, the above described sheets.

### FIELD OF THE INVENTION

The present invention relates to the technical field of interfolded paper products, in particular V-shaped interfolded sheets.

In particular, the invention relates to a pile of interfolded paper sheets, and relative dispenser, in which each sheet of the pile has particular sizes which make it suitable for the use in cooking and food fields.

### BRIEF OUTLINE OF THE PRIOR ART

Paper products, in particular hand towels and/or facial tissues, have been known for a long time. Many types exist, such as V-shaped interfolded sheets.

They are often arranged in suitable dispensers in use in public places such as restaurant toilets, rest areas, etc.

The feature of interfolded sheets is folded and piled sheets so that an edge of a sheet inserts in the fold of the other sheet.

In this manner, by pulling the single sheet, it sticks out of the outlet opening of the dispenser, so that the connection between a sheet and the subsequent occurs so that the other sheet is automatically pulled with the edge thereof out of said opening of the dispenser, ready to be collected.

Many types of interfolded sheets exist, among them the V-folded sheet in which the sheet is simply folded in two overlapping wrap-over halves.

By starting from a parent roll from which the paper unrolls, the machinery which produces the V-shaped interfolded sheet generates a pile of such V-shaped interfolded sheets piled one on top of another through the insertion of an edge of the V-shaped fold of a sheet inside the V-shaped fold of the previous one.

These machineries, well known in the prior art, commonly provide for two counterrotating rolls which suitably fold each sheet so as to produce the pile of interfolded sheets.

Having said that, the sizes of a V-shaped interfolded sheet are such as to make it suitable for the use in toilets, for example for drying face and hands.

In other fields, for example food field and cooking, industrial rolls are usually used, in which the sheet has greater length and width than interfolded paper sheets.

In fact, these industrial paper rolls are commonly visible in kitchens (for example restaurant kitchens as well as fast food counters).

In fact, in kitchens, large work areas as well as hands have to be cleaned, and therefore it is more convenient to have a large sheet.

Nevertheless, the consolidated use of these paper rolls is not free from technical disadvantages since the roll, in particular in public places such as restaurants, is generally mounted within a dispenser containing the reel. However, the roll paper, when unwound from the reel, may often rip incorrectly in a section inside the dispenser.

This may frequently occur in particular if the roll is pulled too strongly during agitated work.

This forces to continuously open the dispenser in order to correctly reposition the paper edge so that it sticks out of the opening.

This continuous opening and closing process is contrary to the current HACCP regulations. In fact, the continuous opening/closing process of the dispenser may cause a contamination of paper with polluting or unclean elements in a working area such as a kitchen.

Moreover, the continuous opening of the dispenser is not only an annoying operation but may also cause the breakage of the dispenser over time.

### SUMMARY OF THE INVENTION

Therefore, the aim of the present invention is to provide an innovative type of paper product for cooking and food fields, which resolves said technical disadvantages.

In particular, the aim of the present invention is to provide a paper product for cooking capable of being easily removable from a dispenser with no risk of tears inside it so as to avoid the inconvenience of a continuous opening of the dispenser, thus reducing the risks of breaking the dispenser and polluting paper.

These and other aims are therefore achieved with the present pile of folded or interfolded paper sheets (f1, f2, fn) for the use in cooking and/or food fields, according to claim 1.

In this pile, each sheet (f1, f2, fn) of said pile (100) has a rectangular shape defined on a side (20′, 20″) which shapes the length (Lu) of the sheet and a side (10′, 10″) which shapes the width (La) of the sheet.

The side which shapes the length (Lu) is the one which is generally V-folded.

According to the invention, length (Lu) of said sheet (f1, f2, fn) is comprised in a range from 20 cm and 42 cm and the width (La) is comprised in a range from 25 cm and 40 cm.

In this manner, all said technical disadvantages are readily resolved.

According to these sizes, the sheet is bigger (i.e. with greater area) than traditional sizes of an interfolded sheet, in particular V-shaped interfolded sheets.

In this manner, due to this increase in size, it is also suitable for use in kitchens and in workplaces in food field.

In this manner it can easily replace the classic roll by providing a special dispenser sized to hold it.

The interfolded sheet, by nature thereof, is a product that is very different from the roll so that, during the extraction thereof, there is no longer the risk of an irregular tear of the paper inside the dispenser, since the sheets are not joined together through a tear line like in the roll.

Therefore, it will no longer be necessary to open the dispenser continuously with the risk of contaminating the paper.

Advantageously, said length (Lu) of said sheet (f1, f2, fn) is comprised in a range from 28 cm and 42 cm and the width (La) is comprised in a range from 25 cm and 35 cm.

Advantageously, the length (Lu) of said sheet is 30 cm and the width (La) of said sheet is 25 cm.

Advantageously, said sheets (f1, f2, fn) of said pile (100) are V-folded.

For this purpose, it is also described here a dispenser for containing a pile of interfolded sheets (f1, f2, fn) as previously described, said dispenser being configured for containing and enabling the collection of said sheets (f1, f2, fn).

Advantageously, the dispenser comprises an outlet opening (56) for collecting the sheet (f1, f2, fn), said opening comprising an antimicrobial additive.

It is also described here a system comprising a pile (100) of folded or interfolded paper sheets (f1, f2, fn) for the use in cooking and/or food fields, and a dispenser for containing said pile, each sheet (f1, f2, fn) of said pile (100) having a rectangular shape defined on a side (20′, 20″) which shapes the length (Lu) of the sheet and a side (10′, 10″) which shapes the width (La) of the sheet.

This system is characterized by the fact that said length (Lu) of said sheet (f1, f2, fn) is comprised in a range from 20 cm and 42 cm and the width (La) is comprised in a range from 25 cm to 40 cm and wherein, further, the dispenser is configured for containing inside said pile of sheets enabling to collect them normally.

Advantageously, said sheets (f1, f2, fn) of said pile (100) are V-folded.

Advantageously, the width (La) of each sheet contained and forming the pile is 25 cm and the length (Lu) is 30 cm.

Advantageously, the dispenser comprises an outlet opening for collecting the sheet (f1, f2, fn), said opening comprising an antimicrobial additive.

### BRIEF DESCRIPTION OF DRAWINGS

Additional features and advantages of the present pile of folded and/or interfolded sheets and relative dispenser will become apparent from the following description of preferred embodiments thereof, given only by way of non-limiting example, with reference to the attached drawings, wherein:

FIG. 1 depicts in a layout drawing the sheet destined to form the pile before being folded;

FIG. 2 depicts with an axis X of symmetry the folding line for obtaining the V-shaped folded sheet;

FIG. 3 depicts an example of V-shaped interfolded sheet;

FIG. 4 depicts an example of a dispenser;

FIG. 5 depicts the open dispenser for loading the pile;

FIG. 6 is a further axonometric view of the dispenser;

FIG. 6A is a sectional transversal view of the dispenser of FIG. 6;

FIG. 7 is a longitudinal section of the dispenser of FIG. 6 for depicting the contents inside, i.e. the pile of interfolded V-shaped sheets.

### DESCRIPTION OF SOME PREFERRED EMBODIMENTS

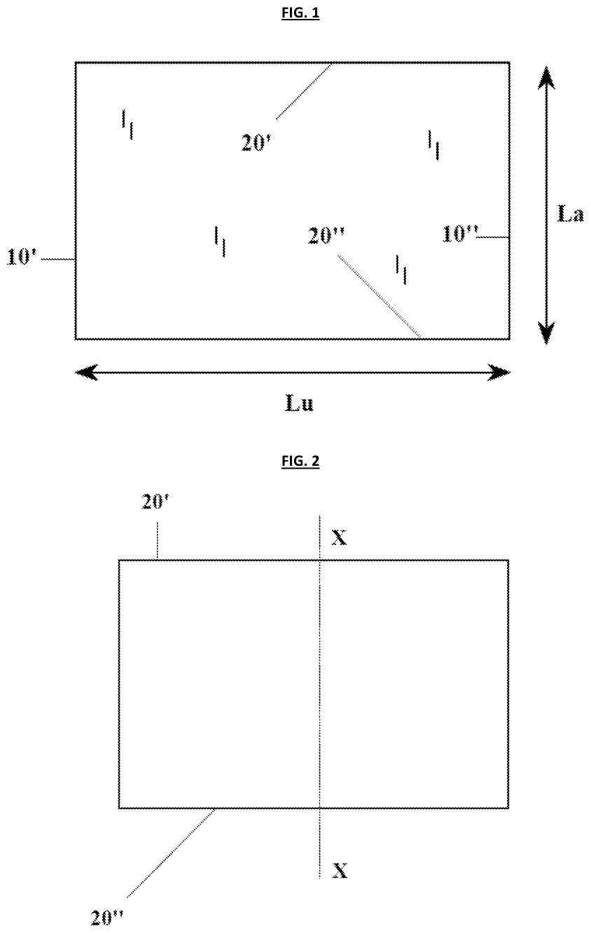

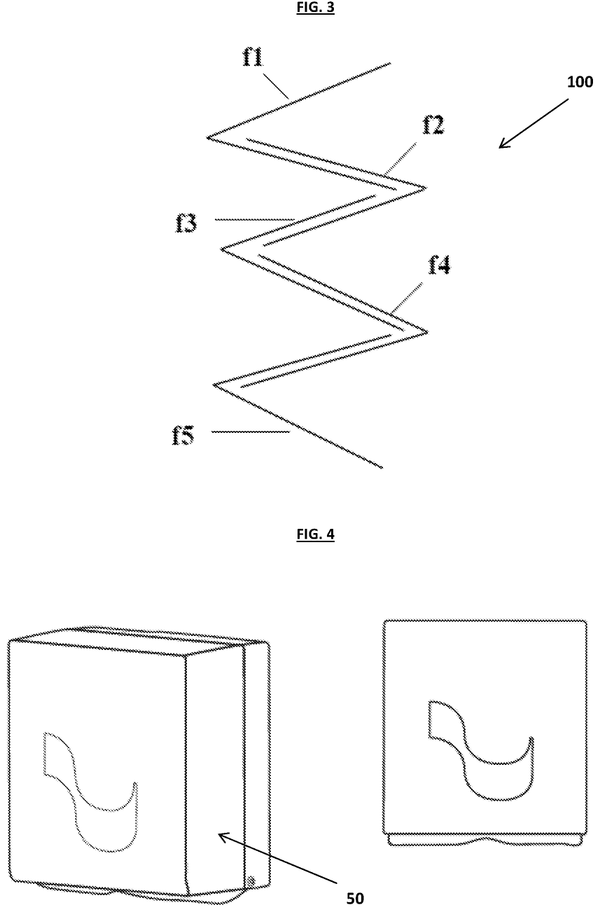

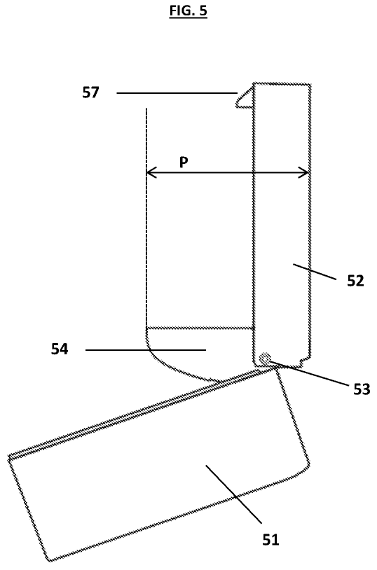

According to the invention, FIG. 1 depicts a layout drawing of a paper sheet for forming the pile of paper sheet.

The sheet is generally rectangular-shaped and comprises two shorter sides parallel to each other (10′, 10″) which represent the width (La) of the sheet and two long sides (Lu) parallel to each other (20′, 20″) which represent the length.

Therefore, the shorter side has a size indicated in figure as La (width) while the longer side has a size indicated in figure as Lu (length).

FIG. 2 depicts the axis of symmetry X-X around which the sheet in the production phase folds for obtaining the V-shaped fold and therefore the pile of interfolded sheets.

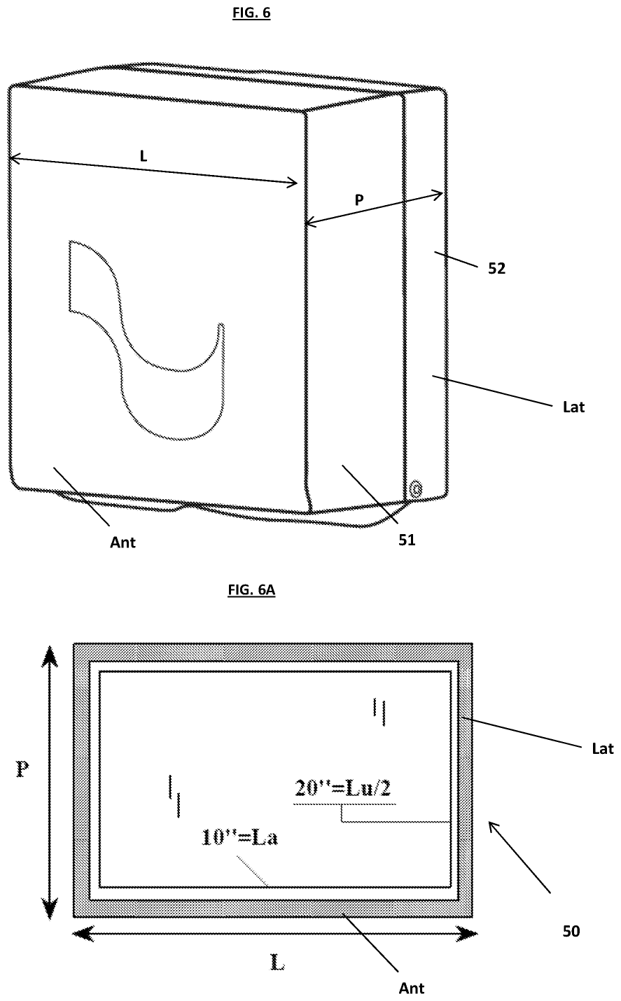

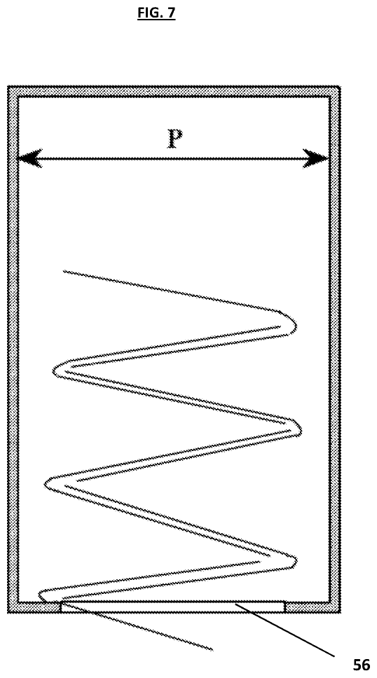

Therefore, the sheet is folded around the axis of symmetry X-X of the side (20′, 20″) which shapes the length (Lu) and then the pile is inserted in the dispenser according to FIG. 6A, i.e. by rotating 90° the sheet of FIG. 1, i.e. so that the side (20′, 20″) folded in half faces the lateral wall (Lat) of the dispenser (see also FIG. 6).

For clarity purposes, FIG. 3 depicts a known pile of interfolded sheets 100 in which the sheet sequence (f1, f2, . . . fn) is made so that an edge of a folded sheet (for example f1) lays on the internal folded edge of the underlying sheet (for example f2), and so on, for the whole sheet sequence.

In brief, an edge of sheet is arranged in the V-shape of the previous and subsequent sheet.

In this manner, as schematically depicted in FIG. 7, the extraction of the sheet sticking out the dispenser pulls the edge of the underlying sheet to the outlet position.

Going back to the invention, with reference to FIG. 1, now the length (Lu) of the sheet is comprised in a range of sizes from 20 cm and 42 cm while the width (La) is comprised in a range from 25 cm and 40 cm.

Preferably, the length (Lu) of said sheet (f1, f2, fn) can be comprised in a range from 28 cm and 42 cm and the width (La) is comprised in a range from 25 cm and 35 cm.

Other particularly preferred sizes can have the length (Lu) comprised in a range from 28 cm and 42 cm while the width (La) can remain comprised in a range from 25 cm to 40 cm.

These size ranges enable to obtain a sheet with grater sizes than usual sizes and particularly suitable for the use in cooking or fields of food processing.

A size that proved to be particularly advantageous is 25 cm, the width (La) of the sheet and 30 cm length (Lu).

In this way, the size of the V-shaped folded sheet is 25 cm×15 cm.

Due to such sizes, the sheet of the pile is perfectly suitable for the use in kitchens for replacing the traditional industrial roll.

A suitable dispenser 50, for example depicted in figures from 4 on, has been produced.

It is generally box-shaped and can be opened for loading it.

FIG. 5 depicts the hinge 53 joining the two box-shaped parts 51 and 52 so that a part 51 can be moved away/close to the other part 52 to be hinged openable/closable by rotating around said hinge 53.

The element 54 indicated in FIG. 5 is a containment bowl 54 provided with the opening 56 for the outlet of the product edge to collect it (see also FIG. 7 which depicts the opening).

FIG. 7 is a simplified section which does not depict the bowl only for descriptive clarity.

In this way, the pile is arranged with the base thereof onto said bowl 54 and can be laid along the length thereof to the part 52. At this point, it is sufficient to close the part 51 with respect to the part 52.

The closure can be snap-like through a releasable system 57, for example a button with return spring.

Alternatively, in combination to what has been previously described, the closure can include a lock safety system which prevent unauthorized openings.

The containment bowl is antimicrobial, so that each sheet collected from the dispenser and laying on this bowl receives a disinfectant action.

This helps to prevent any external contamination.

For this purposes, the containment bowl 54, made by moulding plastic material, contains an antimicrobial mix which mixes with plastic like a normal additive before moulding it.

Usable materials are commonly sold products, such as products by the company Euromaster Srl, which can be found on the following website:

https://www.euromasterspa.com/antimicrobici/

Otherwise, similar products can be found for example on the following website:

http://www.lgholding.it/Masterbatch.html and are defined “Masterbatch”.

Going further with the description of the dispenser, the axonometric view of FIG. 6 depicts the front side (Ant) which has the corresponding rear side and the two lateral sides (Lat). Being box-shaped, it is obviously closed above, as depicted in FIG. 6, while it has an opening at the bottom obtained from the bowl 54 and through which the product edge sticks out. As depicted in FIG. 6, the dispenser must obviously have sizes of width and length such that it can easily contain the pile inside and will conveniently have the classic fixing systems to hang it on the wall.

FIG. 6A shows a cross-section, i.e. a section in which the dispenser in FIG. 6 is cut with a plane parallel to the horizontal plane.

Therefore, FIG. 6A depicts the containment hollow of the dispenser within which the layout drawing of the 20 pile of sheet is visible, highlighting the length (La) side (10′, 10″) of the sheet is in front of the front part (Ant) of the dispenser, while the long side, folded in half for obtaining the V-shape, is positioned in front of the sides (Lat).

FIG. 7 depicts a transversal section, i.e. a cut with a plane orthogonal to the horizontal plane and parallel for example to the side (Lat) of the dispenser for highlighting the piled sheets.

The width of the dispenser, “L” in figures, must be such as to contain the width La of the sheet, while the depths (P) indicates the lateral size of the dispenser which must contain the sheet of predetermined length (Lu)/2 (because it is V-folded).

Having said that, preferably, the dispenser has a size range such as the internal hollow thereof has a width (L) comprised in a range from 26 cm and 41 cm and a depths (P) comprised in a range from 12 cm and 21 cm.

A preferred embodiment comprises a length (L) of approximately 26 cm and a depths (P) of approximately 16 cm.

The invention claimed is:

1. A pile (100) of folded or interfolded paper sheets (f1, f2, fn) for use in cooking and/or food applications, comprising:
each sheet (f1, f2, fn) of said pile (100) having a rectangular shape defined by a side (20′, 20″) which shapes a length (Lu) of the sheet and a side (10′, 10″) which shapes a width (La) of the sheet,
wherein said length (Lu) of said sheet (f1, f2, fn) is comprised in a range from 20 cm and 42 cm and the width (La) is comprised in a range from 25 cm to 40 cm.

2. The pile, according to claim 1, wherein said length (Lu) of said sheet (f1, f2, fn) is comprised in a range from 28 cm and 42 cm and the width (La) is comprised in a range from 25 cm and 35 cm.

3. The pile, according to claim 1, wherein the length (Lu) of said sheet is 30 cm and the width (La) of said sheet is 25 cm.

4. The pile, according to claim 1, wherein said folded or interfolded paper sheets (f1, f2, fn) of said pile (100) are V-folded.

5. A dispenser for containing a pile (100) of folded or interfolded sheets (f1, f2, fn), according to claim 1,
Wherein said dispenser is configured for containing and enabling the pile of said sheets (f1, f2, fn).

6. The dispenser, according to claim 5, further comprising an outlet opening (56) for collecting the sheet (f1, f2, fn), said opening comprising an antimicrobial additive therearound.

7. A system comprising
a pile (100) of folded or interfolded paper sheets (f1, f2, fn) for use in cooking and/or food applications; and
a dispenser for containing said pile,
wherein each sheet (f1, f2, fn) of said pile (100) has a rectangular shape defined by a side (20′, 20″) which shapes a length (Lu) of the sheet and a side (10′, 10″) which shapes a width (La) of the sheet,
wherein said length (Lu) of said sheet (f1, f2, fn) is comprised in a range from 20 cm and 42 cm and the width (La) is comprised in a range from 25 cm to 40 cm, and
wherein the dispenser is configured for containing and enabling to collect said sheets (f1, f2, fn).

8. The system, according to claim 7, wherein said sheets (f1, f2, fn) of said pile (100) are V-folded.

9. The system, according to claim 7, wherein the width (La) of each sheet contained and forming the pile is 25 cm and the length (Lu) is 30 cm.

10. The system, according to claim 9, wherein the dispenser comprises an outlet opening for collecting the sheet (f1, f2, fn), said opening comprising an antimicrobial additive therearound.
